(19) United States
(12) Patent Application Publication
(10) Pub. No.: US 2008/0226502 A1
(43) Pub. Date: Sep. 18, 2008

(54) Microfluidic Methods and Support Instruments

(76) Inventors: Jacques Jonsmann, Gorlose (DK); Jesper Bay, Lyngby (DK)

Correspondence Address: FOLEY HOAG, LLP;PATENT GROUP (w/ISA), 155 SEAPORT BLVD., BOSTON, MA, 02210-2600, US

(21) Appl. No.: 11/994,930

(22) PCT Filed: Jun. 28, 2006
(86) PCT No.: PCT/DK2006/050026

§ 371 Date: Jan. 7, 2008

Related U.S. Application Data
(60) Provisional application No. 60/696,786, filed on Jul. 7, 2005.

(30) Foreign Application Priority Data
Jul. 7, 2005 (DK) PA 2005 01000

(51) Int. Cl. B01J 19/00; B01L 9/00; G05D 16/08; F16K 17/36

(52) U.S. Cl. 422/68.1; 422/104; 137/38

(57) ABSTRACT

A method of performing a test of a liquid sample using a microfluidic device having at least one flow path may include introducing the liquid sample into the flow path and subjecting the microfluidic device to at least one linear motion with an acceleration sufficiently high to affect the flow of the liquid sample in the flow path, the test preferably being a diagnostic test. A support instrument for use in supporting a microfluidic device may include a sustaining arrangement capable of sustaining a microfluidic device, and a motion arrangement capable of subjecting a sustained microfluidic device to at least one linear motion.

### TECHNICAL FIELD

The invention relates to a method of performing a test of a liquid sample using a microfluidic device with one or more flow paths. The invention also relates to a support instrument for use in performing a test as well as a microfluidic system comprising such support instrument.

### BACKGROUND ART

Microfluidic devices comprising one or more flow paths e.g. in the form of flow channels are well known in the art. Such devices normally depend totally or partly on capillary forces to fill the flow path. The geometry of the channels is therefore very important. In certain microfluidic devices additional forces may be applied to fill the flow patch, e.g. centrifugal forces, pumping forces and similar.

Microfluidic devices of this kind are used for performing test of liquid samples. Often it is desired to subject the liquid to various treatments in the microfluidic device, e.g. mixing with other components, dissolving a reagent and optionally allowing the liquid sample to react with a reagent. It is therefore normally desired that the microfluidic device comprises some means for controlling the flow of the liquid sample along the flow path.

U.S. Pat. No. 6,575,188 discloses a microfluidic device comprising a temperature controlled valve. The microfluidic device comprises a thermally responsive substance in its passage which substance can obstruct and open the passage in relation to actuation of a heat source.

US 2003/0196714 discloses a microfluidic device including a bubble valve for regulating a fluid flow through a micro channel. The bubble valve includes a fluid meniscus interfacing the microchannel interior and an actuator for deflecting the membrane into the microchannel interior to regulate the fluid flow. The actuator generates a gas bubble in a liquid in the microchannel when a sufficient pressure is generated on the membrane.

US 2004/0206408 discloses a microfluidic device with a switch for stopping a liquid flow during a time interval. The microfluidic device comprises a capillary stop e.g. provided by a sudden change of the geometrical properties. Similar devices with capillary stops are e.g. disclosed in U.S. Pat. No. 6,637,463 and U.S. Pat. No. 6,591,852.

U.S. Pat. No. 5,230,866 discloses a microfluidic device with a capillary stop-flow junction comprising means for trapping a gas in the capillary passageway to establish a back-pressure to stop the flow in said passageway. When this means for trapping a gas is removed the gas can continue to flow.

All of the above microfluidic devices are relatively expensive to produce because the valve structure/capillary stops necessarily require several additional production steps. Furthermore most of these microfluidic devices are difficult to handle and/or difficult to control to provide a desired capillary stop interval.

Several prior art microfluidic devices use centrifugal forces to overcome capillary stops and to perform other operations in a microfluidic device. Such microfluidic devices are e.g. disclosed in U.S. Pat. No. 4,876,203, U.S. Pat. No. 6,488,827, U.S. Pat. No. 4,883,763 and U.S. Pat. No. 5,627,041.

Centrifugal forces are however not always optimal, in particular because it requires a certain space to rotate a microfluidic device, and also the equipment for performing such rotation may be relatively expensive. Furthermore, many samples will be affected by such rotation whereby the test result may also be affected.

The objective of the present invention is to provide a novel method of handling a microfluidic device during a test, which method can be used as an alternative to the known methods, and which method in many situations is surprisingly beneficial.

Another objective of the present invention is to provide a method of performing a test of a liquid sample using a microfluidic device, which method is both simple and effective.

A further objective of the present invention is to provide a support instrument which can be used for performing the test of the invention, and which is further relatively economical compared with corresponding prior art support instruments.

A further objective of the present invention is to provide a microfluidic system which is both simple and effective to use and relatively economical and which may be used for performing desired diagnostic tests.

### SUMMARY OF INVENTION

These and other objectives as explained in the following have been achieved by the invention as it is defined in the claims.

Hitherto it has been believed that it was difficult or impossible to affect a liquid sample in a controlled manner in a microfluidic system by a simple linear motion without the need for large space. In general it has never been envisaged that it could be possible to affect the liquid in a controlled manner using linear forces. As it is well known to the skilled person liquids behave differently in a microfluidic patch than in a flow path of larger dimensions because surface phenomena have high influences on the flow in a micro dimensioned flow path. Thus, it is e.g. practically impossible to make turbulence in a microfluidic device. Also chemical-physical forces, such as capillary forces and surface tension have more effect than for instance gravity.

It has thus surprisingly been found that it is actually possible to use linear motions to affect the flow in a microfluidic system in a controlled manner during a test.

In particular it has thus been found that linear motions can be used to overcome a capillary stop, to totally or partly mix samples and to increase dissolution of a reagent or another soluble solid. The risk of splitting the liquid sample in micro drops and thereby break a flow has surprisingly shown to be negligible and can easily be avoided by selecting the linear motion to have a sufficient force (acceleration) but not too high force (acceleration) as disclosed below.

The method of the invention of performing a test of a liquid sample using a microfluidic device having at least one flow path comprises the steps of
introducing the liquid sample into the flow path, and
subjecting the microfluidic device to at least one linear motion with an acceleration sufficiently high to affect the flow of the liquid sample in the flow path.

The test may in principle be any kind of test which can be performed in a microfluidic device, such as a diagnostic test, test of foods, test of pollution and other.

In the following the terms hydrophilic and hydrophobic are used as relative terms unless other is specified, i.e. a flow path with at least one hydrophobic surface section and at least one hydrophilic surface section means at least one hydrophobic surface section which is more hydrophobic than the hydrophilic surface section and at least one hydrophilic surface section which is more hydrophilic than the hydrophobic surface section.

The term “flow path” is a pathway arranged in the microfluidic device along which path a liquid sample can flow either by means of capillary forces or by means of a combination of capillary forces and external forces e.g. centrifugal forces, pumping forces, vacuum and similar forces which may pull the sample along the flow path.

Microfluidic devices with one or more flow paths are well known in the art. In principle any micro fluidic device can be used in the invention such as the microfluidic devices disclosed in any of the documents U.S. Pat. No. 6,890,093, U.S. Pat. No. 4,756,884, U.S. Pat. No. 6,637,463, US 2005/0000569, US 2004/020399, U.S. Pat. No. 4,618,476 U.S. Pat. No. 5,300,779, U.S. Pat. No. 6,451,264, PA 2004 01913 DK (U.S. provisional 60/634,289), PA 2005 00057 DK (U.S. provisional 60/642,987) and PA 2005 00732 which with respect to the disclosed microfluidic devices are hereby incorporated by reference.

The flow path may in one embodiment comprise at least one section wherein the sample is subjected to a capillary flow. In one embodiment the flow path has a surface tension and a shape and size arranged so that the sample is subjected to a capillary flow in at least 50% of the length of the flow path, such as at least 60%, such as at least 75% of the length of the flow path.

Table 1 in PA 2005 00732, hereby incorporated by reference, shows examples of surface energy for a number of materials (solids and liquids) in air, at 20° C. The surface energy of water is around 73 mN/m. Aqueous solutions generally have surface energies around 60-77 mN/m, and for many aqueous solutions the surface energy is fairly close to the surface energy of pure water.

The surface energy (also called free surface energy) is a specification of the amount of energy that is associated with forming a unit of surface at the interface between two phases. A surface will be absolutely hydrophilic i.e. have a contact angle towards water of less than 90 degree when the solid-water surface energy exceeds that of the solid-vapour interface. The bigger the difference is, the more hydrophilic the system is. In the same manner a surface can be said to be absolutely liquid-philic (liquid loving) for a certain liquid when the solid-liquid surface energy exceeds that of the solid-vapour interface. The bigger the difference is, the more liquid-philic the system is.

The surface energy and the surface tension are two terms covering the same property of a surface and in general these terms are used interchangeably. The surface energy of a surface or surface section may be measured using a tensiometer, such as a SVT 20, Spinning drop video tensiometer marketed by DataPhysics Instruments GmbH. In this application the terms “surface energy” and “surface tension” designate the macroscopic surface energy, i.e. it is directly proportional to the hydrophilic character of a surface measured by contact angle to water as disclosed below. In comparing measurements, e.g. when measuring which of two surface parts has the highest surface energy, it is not necessary to know the exact surface energy and it may be sufficient to simply compare which of the two surfaces has the lower contact angle to water.

In order to establish a capillary flow of a specific liquid in a flow channel, at least some of the surface of the flow channel wall needs to have a surface energy which can drive the liquid forward. Further information relating to this aspect can e.g. be found in PA 2005 00732.

In one embodiment the flow path comprises at least one section wherein the major part of its circumscribing walls has a surface with a contact angle to the liquid sample of less than 45 degrees, preferably of less than 30 degrees, such as less than 20 degrees, such as less than 10 degrees, such as less than 5 degrees.

In one embodiment wherein the flow path is in form of a flow channel having a bottom surface, a lid surface and two edge surfaces, it is desired that at least a section of said flow path, at least one of said bottom surface, lid surface and two edge surfaces section, preferably at least the bottom surface, has a contact angle to the liquid sample of less than 45 degrees, preferably of less than 30 degrees, such as less than 20 degrees, such as less than 10 degrees, such as less than 5 degrees. The lower the contact angle, the higher the capillary pull will be.

In one embodiment the flow path is defined by at least two opposite channel walls, such as a flow path defined by two opposite walls with opposite path-shaped surface areas with a higher surface tension than the surface tension of the walls beyond the border of the path-shaped surface areas. Such flow path defined by two opposite walls are generally called an edge free flow path, because the flow path does not have a physical edge, but the edge of the flow path is formed because the liquid sample is reluctant to wet the surface with the lower surface tension, beyond the border of the path-shaped surface areas. The distance between the opposite walls may in one embodiment be in the range 1 μm-1000 μm, such as 25 μm-250 μm, such as 50 μm-100 μm.

In one embodiment the flow path is in the form of a flow channel having a bottom surface, a lid surface and two edge surfaces. The distance between the bottom surface and the lid surface in at least a section of said flow channel may preferably be of capillary dimension, more preferably the distance between said bottom surface and said lid surface in at least a section of said flow channel being in the range 1 μm-1000 μm, such as 25 μm-250 μm, such as 50 μm-100 μm.

In one embodiment of the invention the flow path is provided by a base substrate with one or more grooves and a top substrate which are shaped so that when they are joined to each other a cavity is formed, with a distance between the first and the second surface of between 1 μm-1000 μm, such as 25 μm-250 μm, such as 50 μm-100 μm. The cavity may in one embodiment be broader than the flow path, in which case the flow path is provided by arranging at least one or both of the first and second surfaces with one or two hydrophobic border lines along the flow path, the hydrophobic border line being more hydrophobic than the flow path. In this embodiment the flow path is an open flow path with no physical edges, but the edges are provided by the one or more hydrophobic border lines along the flow path. In this embodiment it is desired that the hydrophobic border line(s) has a surface tension of less than 60 mN/m, more preferably less than 30 or even less than 15 mN/m.

In one embodiment the flow path is in form of a flow channel having a bottom surface, a lid surface and two edge surfaces, in at least a section of said flow path at least one of said bottom surface, lid surface and two edge surfaces section, preferably at least the bottom surface, has a surface tension of more than 60, more preferably of more than 70 mN/m, even more preferably of more than 85 mN/m.

In one embodiment of the invention the flow path comprises at least one section wherein the major part of its circumscribing walls has a surface tension higher than the surface tension of the liquid sample, preferably of more than 60, more preferably of more than 70 mN/m, even more preferably of more than 85 mN/m.

In one embodiment the flow path is in the form of a flow channel where the liquid is completely confined by walls except for inlet, outlet and vents.

The flow path may in one embodiment comprise one or more chambers in fluid connection with at least one flow path and optionally with one or more other chambers.

In one embodiment the microfluidic device comprises one or more chambers in the form of flow path sections having more than 50% abrupt increase in cross sectional area in a sectional cut perpendicular to the centre direction of the flow path. Such chambers may e.g. be arranged to be used as reservoir chambers, mixing chambers, reaction chambers, incubation chambers, and termination chambers.

Such chambers may have any size and shape as it is well known in the art e.g. as disclosed in U.S. Pat. No. 5,300,779 and U.S. Pat. No. 5,144,139.

Desired dimensions and shapes of channels and chambers may be as disclosed in our co pending applications Nos. PA 2004 01913 DK corresponding to U.S. provisional Ser. No. 60/634,289 and PA 2005 00057 DK corresponding to U.S. provisional Ser. No. 60/642,987 and PA 2005 00732.

In one embodiment the flow path, e.g. in the form of a channel may thus preferably have a width of at least 5 μm, such as between 10 μm, and 20 mm, such as between 20 μm and 10 mm, and the depth of the channel may preferably be at least 0.5 μm, such as between 1 μm and 1 mm, such as between 5 μm and 400 μm, such as 25 μm and 200 μm.

The said base cavity may comprise one or more edge portions with edge surfaces, which comprise structural edge microstructures, e.g. in the form of one or more of the structural shape gaps, protrusions, and depressions, wherein the edge microstructures preferably are of substantially smaller dimension than the cavity of the base cartridge. Preferably the structural edge microstructures may be as disclosed in any one of our co pending applications Nos. PA 2004 01913 DK corresponding to U.S. provisional Ser. No. 60/634,289 and PA 2005 00057 DK corresponding to U.S. provisional Ser. No. 60/642,987 and PA 2005 00732 incorporated by reference.

In one embodiment of the invention the flow path comprises a capillary stop junction in at least one flow direction. In this embodiment the method of the invention is particularly useful, because the linear motion can be applied to break the capillary stop junction, where after the liquid sample can continue its flow along the flow path. In situation where the flow path comprises a capillary stop junction the flow path section in flow direction before and adjacent to the capillary stop junction is designated “the pre stop junction section for said capillary stop junction”, and the flow path section in flow direction after and adjacent to the capillary stop junction is designated” the post stop junction section for said capillary stop junction”.

The capillary stop junction may be a capillary stop junction in the flow direction, i.e. the flow front of the liquid sample will be stopped at the capillary stop junction. Such a capillary stop junction is referred to as a capillary flow stop junction. Alternatively the capillary stop junction in the direction opposite the flow direction. Such a capillary stop junction is referred to as a capillary depot stop junction. In one embodiment the capillary stop junction is both a capillary flow stop junction and a capillary depot stop junction, i.e. the capillary stop junction is in both direction.

The capillary flow stop junction may in particular be used to stop the flow of the liquid sample for a desired time e.g. for allowing it to dissolve and e.g. react with a reagent applied in the pre stop junction section for said capillary stop junction e.g. adjacent to the capillary flow stop junction. Such reagent may e.g. be applied in a reaction chamber in the flow path. After the liquid sample has remained in such a reaction chamber for a selected time due to the capillary flow stop junction, the microfluidic device is subjected to at least one linear motion whereby the capillary flow stop junction will be overcome and the flow front of the liquid sample can continue flowing along the flow path.

The capillary depot stop junction may in particular be used in situation where another medium (called the second medium) is to be mixed with the liquid sample. This second medium e.g. another liquid and/or a reagent is held in depot in the pre stop junction section for said capillary stop junction, e.g. directly adjacent to the capillary depot stop junction. The microfluidic device may in one embodiment of the method at a selected time be subjected to at least one linear motion whereby the second medium is released from its depot to be mixed with the liquid sample.

It will be clear to the skilled person that there are pluralities of arrangements which can be used without deviating from the principle of the present invention.

In one embodiment the pre stop junction section is a capillary flow section to said liquid sample.

In one embodiment the post stop junction section is a capillary flow section to said liquid sample.

The term “capillary flow section” means a section where the surfaces and/or geometry of the flow path in said section is selected so that the liquid sample will be driven by forces including and/or consisting of capillary forces.

The capillary stop junction may in one embodiment be a temporary stop. Temporary stop means a flow stop which without external influences will be overcome by internal forces such as capillary forces, dissolution forces a.o. within a certain time, such as of at least 1 second, such as of at least 5 seconds, such as of at least 10 seconds, such as of at least 30 seconds, such as up to 1 minute, such as up to 5 minutes, such as up to 10 minutes, such as up to 60 minutes.

The temporary stop may in one embodiment be used as a max time i.e. the liquid sample stopped at a temporary capillary flow stop junction may be observed for a certain reaction e.g. a florescent reaction, a temperature change or other, wherein if said reaction is observed the microfluidic device is subjected to the at least one linear motion to break the capillary flow stop junction, if the reaction is not observed the temporary capillary flow stop junction will be overcome by time. The method of providing flow path with temporary stop is well known.

In one embodiment the capillary stop junction is a full stop. Full stop means a flow stop which without external influences will be maintained.

The capillary stop junction may be provided by any means e.g. by structural abrupt change (i.e. an abrupt change along the flow path) of the walls defining the flow path and/or by abrupt change (i.e. an abrupt change along the flow path) of the surface tension of the walls defining the flow path, e.g. as the capillary stop junctions disclosed in the above referred patent applications and patents.

In one embodiment the capillary stop junction is provided by an abrupt widening of the flow path, preferably an abrupt widening of the cross sectional smallest dimension of the flow path, such as an abrupt widening of the distance between a bottom surface and a lid surface of the flow path.

In one embodiment the capillary stop junction is provided by a hydrophobic barrier, said hydrophobic barrier preferably being formed by a decrease in surface tension of at least a part, preferably the major part of the surface of the flow path circumscribing walls in said capillary stop junction.

In one embodiment the method of the invention comprises the steps of introducing the liquid sample into the flow path, allowing the flow front of said liquid sample to flow to the capillary stop junction, and subjecting the microfluidic device to at least one linear motion with an acceleration sufficiently high to force the flow front of said liquid sample to flow over the capillary stop junction. The liquid sample may be stopped for a desired time at the capillary stop junction prior to subjecting the microfluidic device to the linear motion.

In one embodiment wherein the post stop junction section for said capillary stop junction is a capillary flow section, and the microfluidic device has been subjected to at least one linear motion after the flow front of the liquid sample has been stopped at the capillary flow stop junction for a desired time, the flow front will pass the capillary flow stop junction and thereby wet the capillary flow stop junction, whereby the flow front will continue to flow unhindered along the flow path due to capillary forces.

In one embodiment of the method of the invention it comprises the steps of introducing the liquid sample into the flow path, allowing the flow front of said liquid sample to flow to a desired point along the flow path, and subjecting the microfluidic device to at least one linear motion. In this embodiment there need not be a capillary stop junction, but it should be understood that there could be arranged such capillary stop junction.

At the desired point along the flow path where the microfluidic device is subjected to at least one linear motion, at least a part of the liquid sample may in one embodiment be collected in a reaction chamber, and/or a mixing chamber. In one embodiment the reaction chamber comprises a reagent, such as a solid reagent which is suspended and/or dissolved by the sample. By subjecting the microfluidic device to the linear motion(s) the solid reagent may be suspended/dissolved and mixed faster with the liquid sample. Thus a much faster and more homogenous reaction can be obtained.

In one embodiment, wherein the flow front is allowed to flow to the desired point along the flow path and where a part of the liquid sample is collected in a reaction chamber it may be collected there together with another liquid and the linear motion may result in a totally or partly mixing of the liquids.

As it will be clear to the skilled person the linear motion(s) subjected to the microfluidic device may thus in one embodiment result in a partial or total mixing of the liquid sample with another component. Even when the flow path of the microfluidic device is very small, such as with capillary dimensions, a mixing can in one embodiment be provided by the linear motion(s). This method is thus extremely beneficial, because a certain mixing can be obtained very fast, with limited space, and under high control.

In one embodiment the method may be used for minimising the necessary amount of sample for a test. As it is well known to the skilled person the front part of the liquid sample, often the foremost half part of the sample may be contaminated by various components adhering to the surfaces of the walls defining the flow path. Therefore the part of the liquid sample closest to the flow front is normally not used for measurements, as it may give erroneous result. According to this embodiment of the present invention the liquid closest to the flow front may be used to clean the walls of the flow path. In this embodiment the liquid sample is allowed to flow to a certain point along the flow path, and at least one linear motion is applied so that the linear motion(s) comprises sufficient motion to provide an increased cleaning of the wall surface of the flow path by the liquid sample adjacent to the flow front compared to the cleaning performed with no linear motion. In this embodiment it is desired that the linear motion(s) is applied continuously as the liquid sample flows along the flow path. By selecting the acceleration of the liner motion(s) to be sufficient, but not to high, the surfaces of the walls defining the flow path may be cleaned without resulting in any substantial mixing of the liquid sample. It should be observed that the smaller the dimensions of the flow path the higher acceleration of the linear motion can be applied without resulting in any substantial mixing. The cleaning effect is thus more effective in capillary sections of the flow path than in non-capillary sections of the flow path.

The length of the linear motion has been found to be essentially irrelevant, provided that it has a length. The decisive parameter is the acceleration of the linear motion. Also it has been found that the smaller dimension the flow path has, the larger the acceleration of the linear motion should be to provide the desired effect. In general the linear motion should have an acceleration of at least 1 g. For most applications the acceleration of the linear motion should be higher, such as at least 2 g, such as between 3 and 1000 g, preferably between 5 and 100 g, such as between 8 and 50 g, such as between 10 and 30 g.

It has been found than when acceleration for obtaining a desired effect in a test using a certain microfluidic and a certain type of liquid sample has been found, this acceleration can repeatedly be used with high reliability when performing similar tests using similar microfluidic devices and similar samples.

It is thus very simple to use the method, once the optimal acceleration(s) for the linear motion(s) has/have been found.

In one embodiment of the invention the at least one linear motion results in a linear displacement of the microfluidic device. The length of the linear motion may e.g. be between 1 μm and 1 cm, such as between 10 μm and 0.5 cm, such as between 0.1 and 1 mm. A too large linear motion requires unnecessary space and does not result in any improved effect. Thus it is in principle desired to keep the displacement as small as possible. In one embodiment the displacement of the linear motion(s) is/are in the interval between the 1 and 1000 times the smallest dimension of the flow path at the flow front of the liquid when the linear motion(s) is/are performed.

The linear motion may in principle be performed in any direction relative to the direction of the flow along the flow path at the time the linear motion(s) is/are performed. The linear motion may e.g. be performed in a direction parallel to the flow direction (in or against the flow direction or both), perpendicular to the flow direction or angular to the flow direction with an angle of for example 10, 20, 30, 40, 50, 60, 70 or 80 degrees.

In one embodiment the method comprises the step of subjecting the microfluidic device to a motion comprising a plurality of linear motions, wherein at least two of these linear motions are angular to each other.

In one embodiment wherein the at least one linear motion is performed in a direction compared to the flow direction adjacent the capillary stop junction, which is selected from the group consisting of parallel to the flow direction (in or against the flow direction or both), perpendicular to the flow direction or angular to the flow direction with an angle of for example 10, 20, 30, 40, 50, 60, 70 or 80 degrees.

When the linear motion is used for overcoming a capillary stop junction it may be desired to use only one linear motion, as this in principle should be sufficient. In other embodiments wherein the linear motion serves other purposes, such as mixing, dissolving and etc. it may be desired that the method comprises two or more linear motions.

In one embodiment the method thus comprises the step of subjecting the microfluidic device to a motion comprising 2 or more linear motions with same or different acceleration direction. The 2 or more linear motions may have same or different acceleration. Thus in one embodiment it may be useful to subject the microfluidic device to a first group of linear motions with a first acceleration for mixing and/or dissolving/suspending/reaction purposes followed by a second linear motion of a second and preferably higher acceleration for overcoming a capillary stop.

In one embodiment the method comprises the step of subjecting the microfluidic device to a motion comprising a shake in the form of forwards and backwards linear motions. The method may in this embodiment comprise a plurality of forwards and backwards linear motions.

The linear motion may be provided by any means. In one embodiment the at least one linear motion is provided by net forces due to one or more push of the microfluidic device. The term ‘net force’ means the directional sum of forces.

In one embodiment the at least one linear motion is provided by at least one point force. Such point force may e.g. be in the form of a pull and/or a push.

Any traditional way of applying a point force may in principle be used. Thus in one embodiment the point force is provided by one or more of the elements selected from the group consisting of a piston rod, a spring loaded element, a pneumatic push element and vacuum retract element, a solenoid element, a magnetic element, a piezoelectric element and an electric motor. The skilled person will know that there may be other arrangements which can be used to apply such point force.

In one embodiment the method comprises the step of subjecting the microfluidic device to a linear motion with an acceleration, which acceleration is abruptly stopped or totally or partly reversed, e.g. by a stop element preventing the microfluidic device to be further displaced in the linear motion direction. Thereby the microfluidic device is subjected to a deceleration which may be as effectfull as the acceleration.

In one embodiment the at least one linear motion is provided by net forces due to moving of a support element supporting the microfluidic device. The support element may e.g. be a vibrating support element, e.g. a vibrating support element having a frequency of up to about 100 KHz, such as up to about 10 KHz, such as between 10 and 1000 Hz, such as between 25 and 500 Hz, such as between 50 and 250 Hz.

The invention also relates to a support instrument for use in supporting a microfluidic device when performing a test.

The support instrument of the invention is preferably arranged to be useful in the method of the invention of performing a test as disclosed above.

The support instrument may in one embodiment comprise a sustaining arrangement capable of sustaining a microfluidic device. The sustaining arrangement may e.g. be in the form of a click-lock, a clip, or any other type of holding units which can hold the microfluidic device fixed to the support instrument. In one embodiment the sustaining arrangement is provided by a depression in the support instrument, wherein the depression provides a cavity wherein the microfluidic device can be placed. The depression may be placed along an edge of the support instrument and covered by a lid, so that a slid is formed in the edge of the support instrument through which the microfluidic device can be inserted into the cavity.

The support instrument may comprise a motion arrangement capable of subjecting a sustained microfluidic device to at least one linear motion.

The motion arrangement should preferably be capable of subjecting a sustained microfluidic device to a force which generates an acceleration of the microfluidic device which is sufficiently high to affect a flow of liquid sample in the microfluidic device. The optimal force which can be applied by the motion arrangement depends largely on the microfluidic device, in particular the flow path and also of the liquid sample. In one embodiment the force which can be applied by the motion arrangement is at least 0.1 mN, such as of at least 1 mN, such as of at least 10 mN.

In one embodiment of the support instrument the motion arrangement is capable of subjecting a sustained microfluidic device to at least one linear motion resulting in a linear displacement of the microfluidic device e.g. as disclosed above in the description of the method of the invention.

In one embodiment the motion arrangement is capable of subjecting a sustained microfluidic device to 2 or more linear motions with different acceleration direction.

In one embodiment the motion arrangement is capable of subjecting a sustained microfluidic device to a motion comprising a shake in the form of forwards and backwards linear motions. The motion arrangement may e.g. be capable of subjecting a sustained microfluidic device to a motion comprising a plurality of forth and back linear motions.

In one embodiment the motion arrangement is capable of subjecting a sustained microfluidic device to a motion comprising a plurality of linear motions, wherein at least two of these linear motions may be angular to each other, e.g. perpendicular or in principle with any angel.

In one embodiment of the support instrument of the invention the motion arrangement is capable of subjecting a sustained microfluidic device to a motion provided by net forces due to one or more push of the microfluidic device.

In one embodiment of the support instrument of the invention the motion arrangement comprises a pushing element capable of pushing the microfluidic device and/or a pulling arrangement capable of pulling the microfluidic device, e.g. to be able to provide the microfluidic device with a point force as described above.

In one embodiment of the support instrument of the invention the motion arrangement the pushing element and/or the pulling element comprise one or more of the elements selected from the group consisting of a piston rod, a spring loaded element, a pneumatic push element and vacuum retract element, a solenoid element, a magnetic element, a piezoelectric element and an electric motor. Such elements and methods of arranging them to perform push/pull motions are well known to the skilled person.

The support instrument may in one embodiment further comprise a stop element preventing the microfluidic device to be displaced more than to a selected length in a linear motion direction. The selected length may e.g. be as disclosed above. In one embodiment the selected length is up to 1 cm, such as up to 5 mm, such as up to 2 mm, such as between 10 μm and 1 mm.

The stop element may e.g. be provided by a stop wall of a cavity adapted to hold a microfluidic device.

In one embodiment of the support instrument the motion arrangement comprises both a pushing element/pulling element and a stop element.

In one embodiment the motion arrangement is a vibrating support element arranged to support and thereby be in contact with the microfluidic device.

Such vibrating support element can in principle have any frequencies. Preferred frequencies are up to about 100 KHz, such as up to about 10 KHz, such as between 10 and 1000 Hz, such as between 25 and 500 Hz, such as between 50 and 250 Hz.

The support instrument may further comprise a regulating unit regulating the operation of the motion arrangement. Such regulating element may e.g. regulate the force applied, the time of applying it and other. The regulating element may e.g. comprise a computer and e.g. be controlled by feed-back from the test under progress and/or a software program setting test conditions for the test.

The support instrument may further comprise one or more of the elements selected from the group consisting of sensors, memory chips, display and temperature control unit, injection units for injection one or more fluids, such as reagents, reservoirs, electrodes and magnetic elements. Such elements are well known elements which may be used in combination with the invention. The elements may e.g. be electronic elements.

In one embodiment the support instrument comprises a computer unit, wherein the motion arrangement is connected to be controlled by said computer in regulation to a software program running on said computer.

In one embodiment the support instrument comprises a photodetector arranged to detect the flow in the microfluidic device. The photodetector may e.g. be incorporated in a lid covering a cavity for a microfluidic device or in a photodetector arm extending over the area where a flow path of the microfluidic device is supposed to be placed. The photodetector optionally comprises one or more photodiodes and/or one or more phototransistors.

The invention also relates to a microfluidic system comprising a microfluidic device and a support instrument, both preferably as described above.

The microfluidic device may thus in one embodiment comprise one or more capillary sections to a selected liquid sample and/or one or more capillary stop junction to a selected liquid sample

The motion arrangement of the support instrument may in one embodiment be capable of subjecting the microfluidic device comprising a selected liquid sample to at least one linear motion having a linear acceleration of at least 1 g (9.8 m/s²), such as between 2 and 1000 g, preferably between 5 and 100 g, such as between 8 and 50 g, such as between 10 and 30 g.

The microfluidic system may in one embodiment be in combination with a liquid sample, such as a liquid sample selected from the group consisting of liquids from human beings, animals, microbes, fungis, protozoas, viruses and plants and similar artificial liquids, fractions thereof, solutions, suspensions and dispersions of elements from human beings, animals, microbes, fungis, protozoas, viruses and plants and similar artificial elements, mixtures comprising human, animal, microbiological, virus and plant components and similar artificial components and reaction products thereof.

The microfluidic system may thus be used in a test of one or more of said liquids, wherein the test preferably may be performed according to the method of the invention as described above.

### BRIEF DESCRIPTION OF DRAWINGS

Examples of embodiments of the invention will be described below with reference to the drawings:

FIG. 1 shows a top view of a schematic section of a support instrument according to the invention with a microfluidic device suspended in the support instrument.

FIG. 2 is a top view of a section of another support instrument according to the invention with a microfluidic device suspended in the support instrument.

FIG. 3 is perspective view of a section of a third support instrument according to the invention without a microfluidic device suspended in the support instrument.

The figures are schematic and simplified for clarity, and they just show details which are essential to the understanding of the invention, while other details are left out. Throughout the same reference numerals are used for identical or corresponding parts.

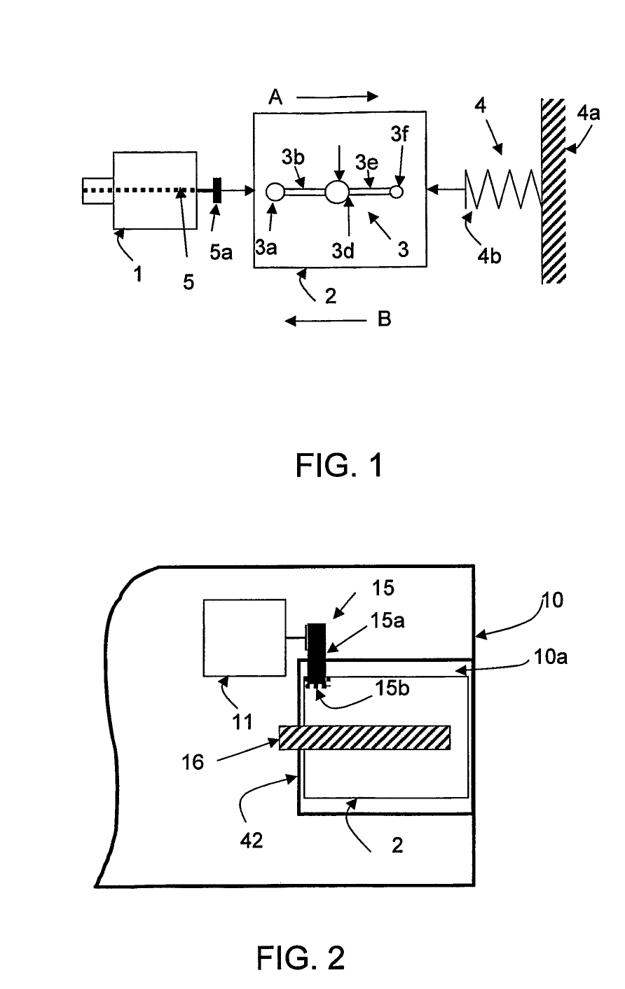

The support instrument schematically shown in FIG. 1 comprises a not shown sustaining arrangement sustaining the microfluidic device 2 so that it is displaceably fixed to the support instrument. The support instrument further comprises a motion arrangement comprising a pushing element 1 and a stop element 4. The pushing element 1 is in the form of a piston with piston rod 5, and a piston head 5a. The stop element 4 comprises a wall section 4a and a spring element 4b. The shown microfluidic device 2 comprises a flow path 3. The flow path 3, comprises an inlet chamber 3a, open to apply a liquid sample, capillary section 3b, a reaction chamber 3c, a capillary stop junction 3d, a capillary post stop junction section 3e for the capillary stop junction, and an opening 3f for allowing gasses to be driven out of the flow path as the liquid sample flow through the flow path.

In use, a liquid sample will be placed at the inlet chamber 3a and the liquid sample will immediately start to flow along the capillary flow path section 3b due to the capillary forces. The liquid will enter the reaction chamber 3c and stop at the capillary stop junction 3d. The reaction chamber may comprise a reagent, and because of the capillary stop the liquid sample will have sufficient time to suspend/dissolve and react with the reagent. For increasing suspending/dissolving and mixing with the reagent, the piston rod 5 may be operating to push the microfluidic device 2 with a force which is less than what is needed to overcome the capillary stop junction. As the piston head 5 hits the microfluidic device 2, the microfluidic device will be subjected to a linear motion in the direction as shown with the arrow A. The microfluidic device 2 will be displaced until it hits the spring element 4b of the stop element 4, whereby the microfluidic device 2 will be decelerated and returned in the direction shown with the arrow B towards the piston head 5.

After a certain preselected time the piston rod 5 will push the microfluidic device 2 with a force which is sufficient to overcome the capillary stop junction, and the flow will continue along the post stop junction section 3e.

The support instrument 10 shown in FIG. 2 comprises sustaining arrangement in the form of a cavity 10a, wherein the microfluidic device 2 can be suspended. The microfluidic device 2 is as the microfluidic device disclosed in FIG. 1.

The support instrument 4 further comprises a motion arrangement comprising a pushing and pulling element and with a piston rod 15 and a piston head 15a. The piston head 15a comprises a fixing element 15 b e.g. a clamp, which is attached to fix the microfluidic device 2. Linear motions can thus be provided by moving the piston rod forward and backward.

The support instrument 4 further comprises a photodetector held by a photodetector arm 16 extending over the area where a flow path of the microfluidic device 2 is placed.

The photodetector can detect the progress of the flow of the liquid sample along the flow path. The motion of the piston rod 15 may thus be regulated in dependence of the signal detected by the photodetector.

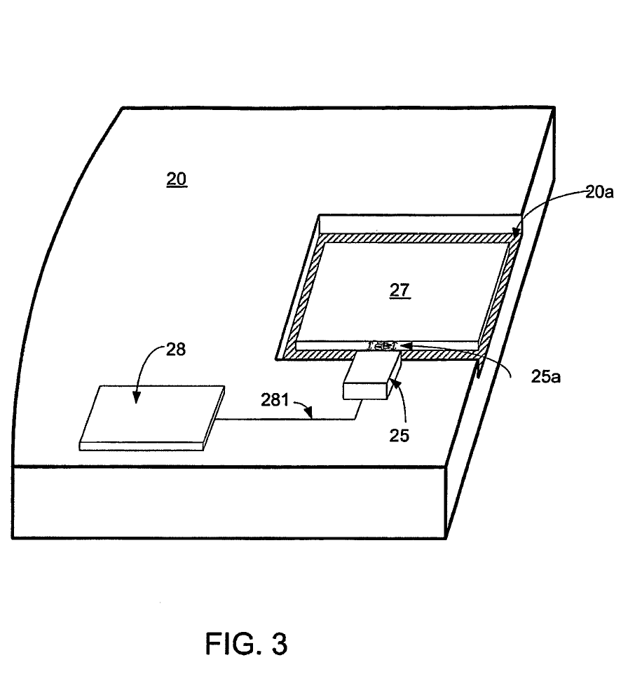

FIG. 3 is perspective view of a section of a third support instrument without a microfluidic device suspended in the support instrument 20. The support instrument 20 comprises a cavity 20 a. In this cavity is a suspension arrangement in the form of a vibrating element 27, e.g. a vibrating plate. The microfluidic device can be placed onto the vibrating element 27, so that it is suspended by the vibrating element 27. The vibrating element 27 is connected in a stiff connection 25a to an actuator 25 e.g. a piezoelectric element. The actuator is linked 281 to a computer 28 for controlling the operation of the actuator. When the actuator 25 is turned on the vibrating element 27 will start to vibrate and a microfluidic device which is suspended by the vibrating element 27 will be subjected to a plurality of linear motions.

1. A method of performing a test of a liquid sample using a microfluidic device having at least one flow path, said method comprising the steps of introducing the liquid sample into the flow path and subjecting the microfluidic device to at least one linear motion with an acceleration sufficiently high to affect the flow of the liquid sample in the flow path.

2. A method as claimed in claim 1, wherein the flow path comprises at least one section wherein the sample is subjected to a capillary flow, the flow path defined by two opposite walls with opposite path-shaped surface areas with a higher surface tension than the surface tension of the walls beyond the border of the path-shaped surface areas.

3. A method as claimed in claim 1, wherein the flow path comprises at least one section with at least one cross sectional dimension in the range 1 μm-1000 μm.

4. A method as claimed in claim 1, wherein the flow path is in the form of a flow channel having a bottom surface, a lid surface and two edge surfaces, distance between said bottom surface and said lid surface in at least a section of said flow channel being in the range 1 μm-1000 μm.

5. A method as claimed in claim 1, wherein the flow path comprises at least one section wherein the major part of its circumscribing walls has a surface tension higher than the surface tension of the liquid sample.

6. A method as claimed in claim 1, wherein the flow path is in the form of a flow channel having a bottom surface, a lid surface and two edge surfaces, and in at least a section of said flow path at least one of said bottom surface, lid surface and two edge surfaces section has a surface tension of more than 60 mN/m.

7. A method as claimed in claim 1, wherein the flow path comprises at least one section wherein the major part of its circumscribing walls has a surface with a contact angle to the liquid sample of less than 45 degrees.

8. A method as claimed in claim 1, wherein the flow path is in the form of a flow channel having a bottom surface, a lid surface and two edge surfaces, and in at least a section of said flow path at least one of said bottom surface, lid surface and two edge surfaces section has a contact angle to the liquid sample of less than 45 degrees.

9. A method as claimed in claim 1, claims, wherein the flow path comprises a capillary stop junction in at least one flow direction, the flow path section in flow direction before and adjacent to the capillary stop junction is designated ‘pre stop junction section for said capillary stop junction’ and the flow path section in flow direction after and adjacent to the capillary stop junction is designated ‘post stop junction section for said capillary stop junction’.

10. A method as claimed in claim 9, wherein the flow path comprises a capillary stop junction in the flow direction.

11. A method as claimed in claim 9, wherein the flow path comprises a capillary stop junction in the direction opposite the flow direction.

12. A method as claimed in claim 9, wherein the pre stop junction section is a capillary flow section to said liquid sample.

13. A method as claimed in claim 9, wherein the post stop junction section is a capillary flow section to said liquid sample.

14. A method as claimed in claim 9, wherein the capillary stop junction is a temporary stop that provides a capillary stop of at least 1 second.

15. A method as claimed in claim 9, wherein the capillary stop junction is a full stop.

16. A method as claimed in claim 9, wherein the capillary stop junction is provided by an abrupt enlargement of the cross sectional smallest dimension of the flow path.

17. A method as claimed in claim 9, wherein the capillary stop junction is provided by a hydrophobic barrier.

18. A method as claimed in claim 9, further comprising introducing the liquid sample into the flow path, allowing the flow front of said liquid sample to flow to the capillary stop junction, and subjecting the microfluidic device to at least one linear motion with an acceleration sufficiently high to force the flow front of said liquid sample to flow over the capillary stop junction.

19-40. (canceled)

41. A support instrument for use in supporting a microfluidic device, wherein said support instrument comprises a sustaining arrangement capable of sustaining a microfluidic device, and a motion arrangement capable of subjecting a sustained microfluidic device to at least one linear motion.

42-61. (canceled)

62. A microfluidic system comprising a microfluidic device and a support instrument as claimed in claim 41, wherein the microfluic device defines at least one flow path, the flow path comprises a capillary stop junction in at least one flow direction, and the motion arrangement of the support instrument is capable of subjecting the microfluidic device to at least one linear motion sufficient to cause a liquid sample in the microfluidic device to overcome the capillary stop junction.

63-80. (canceled)
